(19) United States
(12) Patent Application Publication
(10) Pub. No.: US 2011/0145934 A1
(43) Pub. Date: Jun. 16, 2011

(54) AUTONOMOUS DISTRIBUTED PROGRAMMABLE LOGIC FOR MONITORING AND SECURING ELECTRONIC SYSTEMS

(76) Inventors: Miron ABRAMOVICI, Berkeley Heights, NJ (US); Paul BRADLEY, Cumberland, RI (US); David J. WHELIHAN, Framingham, MA (US)

(21) Appl. No.: 12/903,890

(22) Filed: Oct. 13, 2010

Related U.S. Application Data
(60) Provisional application No. 61/251,246, filed on Oct. 13, 2009.

(51) Int. Cl. G06F 21/24

(52) U.S. Cl. 726/30

(57) ABSTRACT

Methods and apparatuses are described herein for securing a mission logic system using one or more distributed, independent programmable security logic blocks. The security logic blocks may monitor subsystems of the mission logic system and/or communication between subsystems. If the security logic blocks determine that the mission logic system is operating in an unauthorized manner, the security logic blocks may enforce a protection mechanism. The security logic blocks may include an interface for receiving communications from the subsystems, an analysis instrument for analyzing the communications, a transport instrument for routing communications from the interface to the analysis instrument, and a control instrument for enforcing the protection mechanism on the basis on an analysis performed by the analysis instrument.

### RELATED APPLICATIONS

This application is a continuation-in-part of U.S. patent application Ser. No. 12/407,537, filed on Mar. 19, 2009, and further claims priority to U.S. Provisional Application No. 61/251,246, filed on Oct. 13, 2009. This application is further related to U.S. patent application Ser. No. 10/425,101, filed on Apr. 28, 2003, now U.S. Pat. No. 7,068,918, issued on Jun. 6, 2006. The contents of the aforementioned patents and applications are incorporated herein by reference.

### BACKGROUND

With advances in computing capacity, more complex systems are being constructed within smaller and smaller physical devices. Such physical changes have enormous impact on security as private or proprietary information is entered, stored, received and transmitted by such small computing devices. In addition, the designers and manufacturers of the embedded systems must also secure the system itself to prevent intellectual property from being compromised.

There are numerous methods for securing such systems, including encryption and obfuscation of both the hardware and software components and information transfers. However, the incremental cost for securing such systems limits the extent to which such measures can be implemented as the embedded systems are often utilized within applications such as cellular phones, personal digital assistants and portable media players where low cost material is of primary concern and efforts to continuously reduce cost are undertaken. The cost to implement such security measures often prohibits economical delivery of embedded systems solutions required by the market.

Moreover, the economics of hardware security methods are further complicated by the fact that once a hardware system is compromised it is often cost prohibitive to patch or upgrade hardware, yet without such counteracting measures the system remains vulnerable.

Whereas existing techniques rely on a processor or a centralized fixed logic security function within the hardware subsystem, these techniques have significant drawbacks. Relying on a processor and the software executing on it to provide security monitoring functions exposes the system to a primary attack vector—malicious software (e.g. malware). If the processor is co-opted the security monitoring functions can be disabled. Relying on centralized fixed logic security functions embedded in the hardware provides more resiliency against software based attacks, but here again there are drawbacks to this approach. Using fixed logic implies the security monitoring functionality must be defined completely during the hardware design process. This solution is “static”—meaning it cannot be modified post-deployment to address new threats.

In practice it is often difficult to anticipate all possible threat vectors at design time and therefore difficult to design a solution that provides sufficient coverage. Consider that new security threats and related vulnerabilities are discovered every day. With financial, technological and even political forces at work we must anticipate an ever escalating array of threat vectors.

### SUMMARY

The present application provides methods and apparatuses to improve the security of systems composed of custom hardware devices such as, but not limited to, Field Programmable Gate Arrays (FPGAs) and Application Specific Integrated Circuits (ASICs), processors and software that runs on one or more processors and interacts with other circuitry within an embedded system.

The system (referred to herein as a “mission logic system”) may be secured by one or more electronic devices (referred to herein as “programmable security logic blocks”) distributed in the mission logic system but otherwise independent of the mission logic system. The programmable security logic blocks may operate autonomously.

The programmable security logic block may include an interface receiving communications associated with one or more subsystems of the mission logic system and an analysis instrument for monitoring the one or more subsystems or communication between the one or more subsystems to determine whether the mission logic system is performing in an authorized or unauthorized manner.

The interface may receive one or more mission logic signals from the mission logic subsystems, and route the mission logic signals to the analysis instrument with the assistance of a transport instrument.

The analysis instrument may, for example, monitor the signals to detect a predetermined signal or a predetermined sequence or combination of signals. Further, the programmable security logic may perform hardware authentication functions, and may provide a heartbeat indicating that the programmable security logic is operating properly. One programmable security logic block may also be used to monitor another programmable security logic block to ensure that the other programmable security logic block is operating properly.

The programmable security logic block may further include a control instrument for enforcing a protection mechanism when an analysis instrument determines that the mission logic is performing in an unauthorized manner. The protection mechanism may include, for example, blocking access to a system resource, erasing predetermined data, and/or disabling one or more communication peripherals in order to quarantine the system in response to a determination by the analysis instrument that the system is performing in an unauthorized manner.

Using the programmable security logic blocks of the present application, the hardware and software of mission logic systems may be protected from unauthorized modifications and/or unauthorized operations. The security logic blocks may further be used to protect sensitive data and make assurances to software that certain hardware is present and performing as expected.

### BRIEF DESCRIPTION OF DRAWINGS

FIG. 1 is a block diagram of an exemplary mission logic system which is one example of a system to be secured.

FIG. 2 is a block diagram of the exemplary mission logic system of FIG. 1 with an exemplary embodiment of distributed programmable security logic.

FIG. 3 is a block diagram of an embodiment of one instance of distributed programmable security logic between two blocks of a mission logic system, where the distributed programmable security logic is composed of transport, control and analysis logic.

FIG. 4 is a block diagram of an embodiment of one instance of distributed programmable security logic between two blocks of a mission logic system, where the distributed programmable security logic is composed of analysis logic.

FIG. 5 is a block diagram of a mission logic system with an embodiment of distributed programmable security logic, showing how each instance of the programmable security logic may be different in form and in connectivity to adjacent instances.

FIG. 6 is a block diagram of a basic multiplexer structure used to transport mission logic signals to analysis instruments.

FIG. 7 is a block diagram of a more advanced multiplexer structure used to transport mission logic signals to analysis instruments.

FIG. 8 is a block diagram of an analysis instrument composed of Look-Up-Table and Status Register used to perform security functions with Boolean logic.

FIG. 9 is a block diagram of an analysis instrument composed of a parameterize comparator and small finite state machine used to perform security functions with pattern match logic.

FIG. 10 is a block diagram of an analysis instrument composed of a programmable finite state machine, comparators, Boolean logic unit, timers and counters used to perform security functions with advance sequential logic analysis.

FIG. 11 is a block diagram of a dynamic control instrument.

FIG. 12 is a block diagram of a static control instrument.

FIG. 13 is a flowchart showing an exemplary design flow.

FIG. 14 is a block diagram of an exemplary configuration controller.

### DETAILED DESCRIPTION

The present application provides methods and apparatuses to improve the security of systems composed of custom hardware devices such as, but not limited to, FPGAs and ASICs, processors and software that runs on one or more processors and interacts with other circuitry within an embedded system. Using the exemplary methods and systems described herein, electronic systems may be monitored and secured using a custom, autonomous, distributed, programmable logic fabric within the hardware system. The hardware system is referred to herein as a mission logic system, which is a hardware system that performs a task according to specified logic.

Hardware-based security offers additional security to a system beyond what software-only schemes can provide. Unless the software security is rooted in hardware, even attackers with moderate to low technological skills can compromise the software. Consider a system in which the software instruction is wholly contained within a storage device (e.g. Flash), a chip on an electronic circuit board. By replacing the code on the storage device or the device itself, the functionality of the system can be co-opted and most software based security mechanisms previously contained within the storage device can be removed. If, on the other hand, there is some dependency between the software and hardware, removing security code or other critical code is more difficult.

Using distributed programmable security logic allows the programming configuration (e.g. software) to be uniquely structured for each design, unlike software running on a common processor, and the programmable hardware is by its nature hard to identify and understand by a potential attacker due to its embedded and distributed form. Constructing a security mechanism in this manner enables a wide range of protection mechanisms.

The programmable security logic of the present application may include one or more distributed security devices which monitor and analyze hardware specific behaviors, measure timing intervals of certain events, and authenticate hardware. The programmable logic can be configured to perform a variety of security functions, from monitoring the state of a single signal to monitoring for specific transactions, state sequences of a multitude of signals, between two or more disparate resources. The security function can be defined at any time and is only limited by the logic resources therein.

The methods described herein may implement discrete security functions within numerous localized regions of the mission logic system to provide fine grained and targeted visibility into specific mission logic behavior, while at the same time constructing a structure that facilities a more global view of the system behavior through the collection of information from each discrete instance to facilitate detecting security violation and providing countermeasures to the detected threats.

The programmable security logic of the present application may be used to secure, for example, an ASIC or an FPGA. An ASIC is an integrated circuit (IC) customized for a particular use, rather than intended for general-purpose use. An FPGA is an integrated circuit designed to be configured by the customer or designer after manufacturing—hence “field-programmable.” The FPGA is a type of Programmable Logic Device (PLD). A PLD is an electronic component used to build reconfigurable digital circuits. Unlike a logic gate, which has a fixed function, a PLD has an undefined function at the time of manufacture. Before the PLD can be used in a circuit it must be programmed, that is, reconfigured.

For the sake of clarity, note that the proposed method may be implemented within a single semiconductor device(but is not limited to such), a FPGA or ASIC that contains processors and corresponding software instruction, or it may be a printed circuit board assembly containing multiple FPGAs and/or ASICs, discrete or embedded processors and additional hardware circuitry.

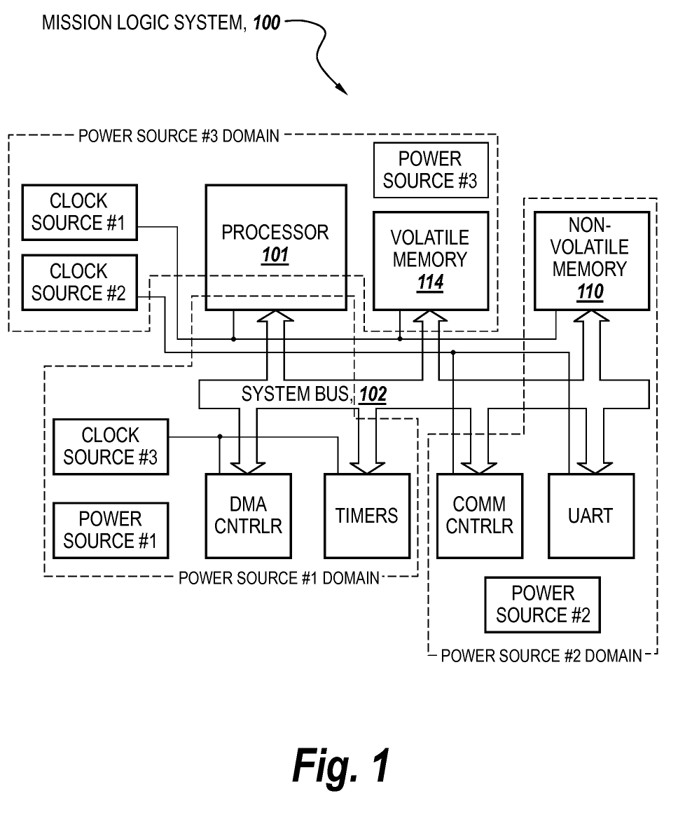

One example of an exemplary mission logic system which may be secured using the methods and apparatuses described herein is depicted in FIG. 1.

The mission logic system 100 may be composed of one or more processors, memories, controllers and communication peripherals. Note that such systems are often constructed using multiple voltage sources and clock sources. The present invention is not dependent on the use of any specific types of mission logic circuit; in fact it is completely agnostic to the hardware architecture and components therein.

The exemplary mission logic system 100 includes a processor 101. The processor 101 may include hardware or software based logic to execute instructions on behalf of the mission logic system 100. In one implementation, the processor 101 may include one or more processors, such as a microprocessor. In one implementation, the processor 101 may be hardware, such as a digital signal processor (DSP), a field programmable gate array (FPGA), a Graphics Processing Unit (GPU), an application specific integrated circuit (ASIC), a general-purpose processor (GPP), etc., on which at least a part of applications can be executed. In another implementation, the processor 101 may include single or multiple cores for executing software stored in a memory, or other programs for controlling the mission logic system 100.

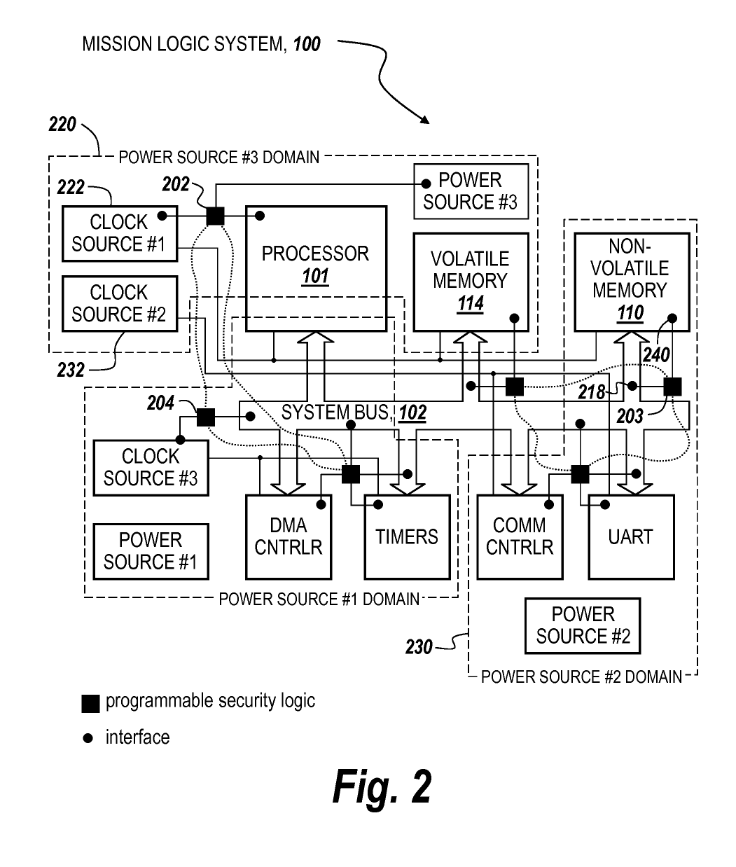

It should be noted that the mission logic system 100 depicted in FIGS. 1 and 2 is only one example of a mission logic system suitable for use with the present invention. In other embodiments, the mission logic system 100 may include more or fewer components. The mission logic system 100 may also be implemented in a single chip including one or more subsystems. The security logic described herein is generally agnostic as to the type of mission logic system 100 employed, and one of ordinary skill in the art will recognize that other types of mission logic systems may be used without deviating from the scope of the present invention.

The present invention may be implemented on systems based upon different types of microprocessors, such as Intel microprocessors, the MIPS® family of microprocessors from the Silicon Graphics Corporation, the POWERPC® family of microprocessors from both the Motorola Corporation and the IBM Corporation, the PRECISION ARCHITECTURE® family of microprocessors from the Hewlett-Packard Company, the SPARC® family of microprocessors from the Sun Microsystems Corporation, or the ALPHA® family of microprocessors from the Compaq Computer Corporation.

The processor 101 may communicate via a system bus 102 to a peripheral device 103. A system bus 102 may be, for example, a subsystem that transfers data and/or instructions between other subsystems of the mission logic system 100. The system bus 102 may transmit signals along a communication path defined by the system bus 102 from one subsystem to another. These signals may describe transactions between the subsystems.

The system bus 102 may be parallel or serial. The system bus 102 may be internal to the mission logic system 100, or may be external. Examples of system buses 102 include, but are not limited to, Peripheral Component Interconnect (PIC) buses such as PCI Express, Advanced Technology Attachment (ATA) buses such as Serial ATA and Parallel ATA, HyperTransport, InfiniBand, Industry Standard Architecture (ISA) and Extended ISA (EISA), MicroChannel, S-100 Bus, SBus, High Performance Parallel Interface (HIPPI), General-Purpose Interface Bus (GPIB), Universal Serial Bus (USB), FireWire, Small Computer System Interface (SCSI), and the Personal Computer Memory Card International Association (PCMCIA) bus, among others.

In some embodiments, the system bus 102 may include a network interface. The network interface may allow the mission logic system 100 to interface to a Local Area Network (LAN), Wide Area Network (WAN) or the Internet through a variety of connections including, but not limited to, standard telephone lines, LAN or WAN links (e.g., T1, T3, 56kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 808 may include a built-in network adapter, network interface card, personal computer memory card international association (PCMCIA) network card, card bus network adapter, wireless network adapter, universal serial bus (USB) network adapter, modem or any other device suitable for interfacing the mission logic system 100 to any type of network capable of communication and performing the operations described herein.

The mission logic system 100 may include one or more types of non-volatile memory 110, such as flash memory, and/or one or more types of volatile memory 114, such as Dynamic Random Access Memory (DRAM) or Static Random Access Memory (SRAM), among others.

Flash memory includes may be non-volatile storage that can be electrically erased and reprogrammed. Flash memory is used, for example, in solid state hard drives, USB flash drives, and memory cards. In some embodiments, the flash memory may be read-only. In other embodiments, the flash memory may allow for rewriting.

DRAM includes random access memory (RAM) that stores data using capacitors. Because capacitors may leak a charge, DRAM is typically refreshed periodically. In contrast, SRAM does not usually need to be refreshed.

The mission logic system 100 may be secured using distributed programmable security logic blocks 202, 203, 204, as depicted in FIG. 2. In one embodiment of a security method, multiple instances of programmable security logic blocks 202 are distributed throughout the mission logic system 100 as shown in FIG. 2.

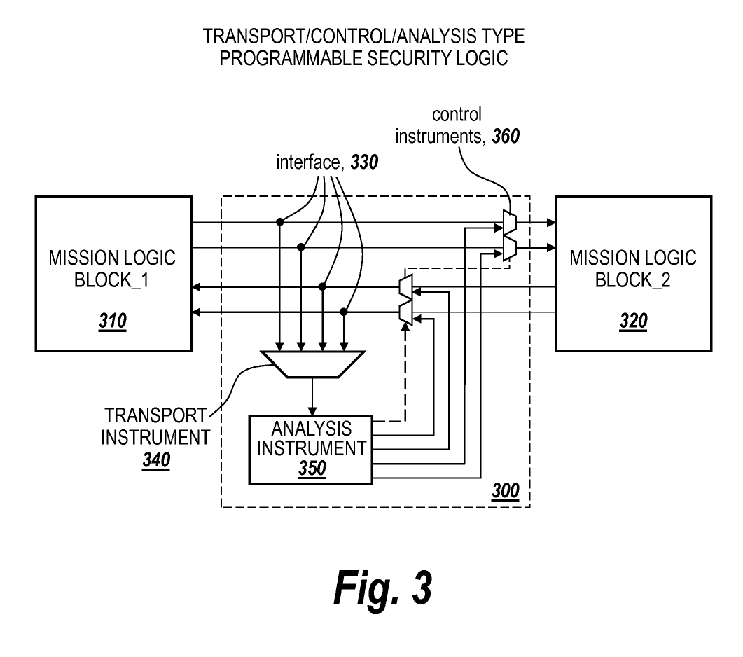

The programmable security logic blocks 202, 203, 204 may include one or more interfaces for receiving communications related to one or more of the subsystems of the mission logic system 100. The interface connects the programmable security logic blocks to the subsystems of the mission logic system 100, either directly or through a communications path, so that the programmable security logic blocks can send communications to, and receive communications from, the subsystems. For example, the programmable security logic block 203 includes an interface 210 connecting the programmable security logic block 203 with the non-volatile memory 110, and a second interface 212 for connecting the programmable security logic block 203 to the system bus 102. The interfaces will be discussed in more detail below with respect to FIGS. 3 and 6-7.

The programmable security logic blocks 202, 203, 204 can be configured to perform a variety of security functions, from monitoring the state of a single signal to monitoring for specific transactions, state sequences of a multitude of signals, between two or more disparate resources. Such programmable security logic blocks 202, 203, 204 can, for example, guard an addressable memory range against unauthorized access and interrupt such accesses in real time to prevent access to or corruption of privileged data. The security function can be defined at any time and is only limited by the logic resources.

The distributed programmable security logic blocks 202, 203, 204 can be configured to perform coordinated functions. For example, one programmable security logic block 203 may measure the performance of the system bus 102 while another programmable security logic block may use these results to compute alerts when certain thresholds are detected.

The programmable security logic blocks 202, 203, 204 can operate independent from the mission logic and other programmable security logic resources. That is, the programmable security logic blocks may be capable of performing a security function without relying on the resources of the mission logic and/or other programmable security logic blocks. Thus, the programmable security logic blocks 202, 203, 204 may be autonomous. In one embodiment, each programmable security logic block 202, 203, 204 can execute concurrently.

Given their small size, the programmable security logic blocks 202, 203, 204 can be inserted into many parts of the mission logic system and via reprogramming can provide both a fine grain (e.g. single signal) or system wide (e.g. many signals and transactions) views and therefore analysis of the mission logic behavior.

The programmable security logic blocks 202, 203, 204 are designed with built in redundancy and resides in multiple clock, power and spatial domains to reduce the risk that an attack (or defect) induced failure in one part of the security system will take down the entire security system. For example, in FIG. 2 the programmable security logic block 202 resides in the power source #3 domain 220 and connects to clock source 222. The programmable security logic block 202 is physically located between the processor 101 and the clock source 222. Meanwhile, the programmable security logic block 203 resides in the power source #2 domain 230 and connects to the non-volatile memory 110, which receives a clock signal from clock source 232. The programmable security logic block 203 is physically located on the opposite side of the mission logic system from the programmable security logic block 202.

The programmable security logic blocks 202, 203, 204 can be configured to provide both pro-active and reactive protection mechanisms in real-time. Proactive mechanisms can include blocking processor access to privileged resources. Reactive mechanisms can include erasing sensitive data when tampering is detected, and permanently disabling electronic circuits, and disabling communication peripherals in order to quarantine a suspect system.

The programmable security logic blocks 202, 203, 204 can be configured to perform a variety of security functions, from monitoring the state of a single signal to monitoring for specific transactions, state sequences of a multitude of signals, between two or more disparate resources. The security function can be defined at any time and is only limited by the logic resources therein.

Examples of security function include, but are not limited, to the following:

monitor the IEEE 1149.1 JTAG TMS and TDI signals for transitions (0->1, 1->0 switching) to detect unauthorized attempts to access internal chip information from this standard chip interface;

monitor memory address lines and control signals, such as Read Enable and Write Enable, to detect unauthorized attempts to access restricted memory space;

monitor processor bus inactivity levels (e.g. latency between bus cycles) to detect the absence of required bus transfer rates, indicating the possible presence of malware;

monitor memory read and write access rates to specified address ranges with comparisons to expected values to detect unexpected levels and the possible presence of malware;

monitor the individual and cumulative transmission data rates of specific peripheral interfaces, in conjunction with instruction space accesses and bus transfer performance levels to detect the possible presence of malware used for data exfiltration; and

monitor the reset signal(s), instruction fetches, memory ranges and configuration registers in communication peripherals, after the system is released from the reset state to check for proper fetch, and expected memory and register accesses during this deterministic phase of operation. Unexpected events may indicate the presence of a rootkit or boot time intrusive tampering.

Due to the fact that the programmable security logic is reprogrammable, ubiquitous, can monitor and analyze hardware specific behaviors, and measure timing intervals of certain events, the security logic is well suited for hardware authentication. Authentication in this context refers to the process of allowing software operating in the mission logic system 100 to determine whether the hardware is what the software expects the hardware to be, and whether the hardware can establish a trusted relationship with the software. Using the methods described herein to take advantage of the reprogrammability of the programmable security logic blocks 202, 203, 204, the manner in which the hardware is verified may be changed such that an attacker using emulation, counterfeit parts, or software simulators (to name but a few examples), can not anticipate how the hardware is supposed to response to software authentication enquiries.

One example of an authentication technique causes the software to initiate a test to verify the existence of all expected programmable security instruments. When said test is started a programmable security instrument is configured to start a timer and at the completion of the test, the timer value is read by the software as a means to verify that the actions completed where done so at a performance level achievable only in hardware (not software emulation or simulation). Existence can be verified by reading and writing registers and capturing deterministic mission logic signal values for the software to check against expected values.

In another embodiment of authentication, the software initiates a test using each appropriate programmable security resource to measure hardware activity in each locale. For example a memory subsystem can be verified by executing a software based diagnostic that reads and write select memory locations at a multitude of intervals, subsequent to configuring the programmable security logic to measure the latency between read and write cycles, while also hashing the values transferred and hashing the timestamp value at each transfer. If the final hash computed by the programmable security logic does not match the expected value, the memory subsystem is deemed untrustworthy. Note that the expected hash value will be computed in advance in a trusted environment and only with access to the authentic hardware design. Note that the programmable security logic configuration files are encrypted making reverse engineering of the logic and the authentication method more difficult.

In one embodiment, the collection of all such tests can serve as an immutable “hardware signature”

In another embodiment of authentication, the software configures each programmable security logic resource to record the state of each of the thousands of attached mission logic signals using a deterministic state sampling method. The software places the system in a known state to initiate this test. The expected values are compared to the actual values. Those skilled in the art understand that verifying the correct state of thousands of mission logic signals over a period of time with the software controlling the expected state of the system is very difficult to emulate or spoof.

The existence of the programmable security logic blocks 202, 203, 204 in numerous ASICs, ASSPs and FPGAs makes counterfeiting difficult. Because the authentication process utilizes hardware, it is more difficult to emulate in software due to performance limitations.

FIG. 3 is a block diagram of an embodiment of one instance of distributed programmable security logic block 300 between two blocks 310, 320 of a mission logic system, where the distributed programmable security logic is composed of transport, control and analysis instruments. The programmable security logic block 300 is composed of multiple logic circuits with transport, control and analysis purposes that once programmed can implement a variety of security functions.

The programmable security logic block 300 includes one or more interfaces 330 for receiving communications associated with one or more of the mission logic blocks 310, 320. The interfaces 330 may be, for example, a tap on a communications path between the mission logic blocks 310, 320. Although FIG. 3 depicts the interfaces 330 as receiving communication between two mission logic blocks 310, 320, an interface 330 may also connect directly to one of the mission logic blocks 310, 320. Alternatively, an interface 330 may be used to facilitate communication between two programmable security logic blocks 300.

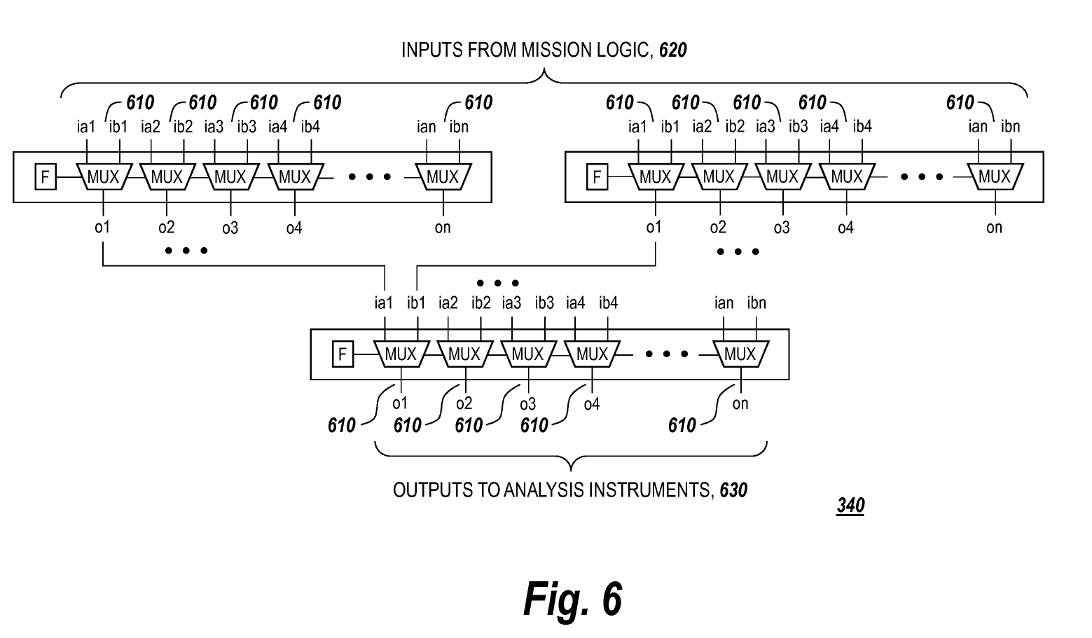

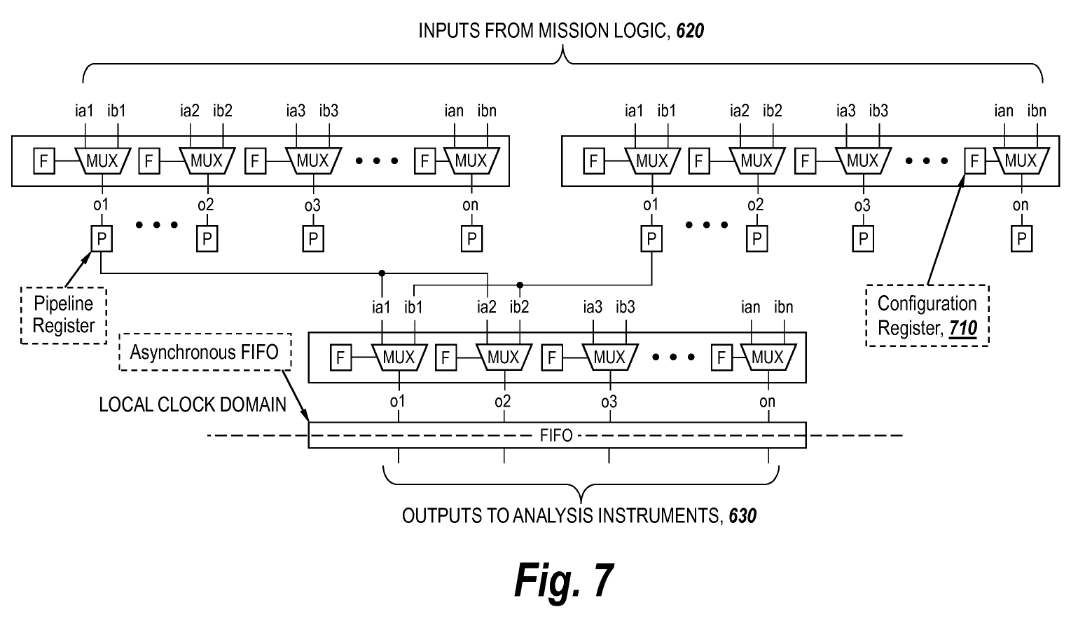

The transport instrument 340 is responsible for routing combinations of mission logic signals to the analysis instrument 350. For example, the transport instrument 340 may multiplex incoming signals from the interface 330 and transmit the multiplexed signals to the analysis instrument 350. The transport instrument 340 may be part of an interface 330 (or vice versa), or the transport instrument 340 may be separate from the interface 330. The transport instrument 340 will be discussed in more detail below with respect to FIGS. 6-7.

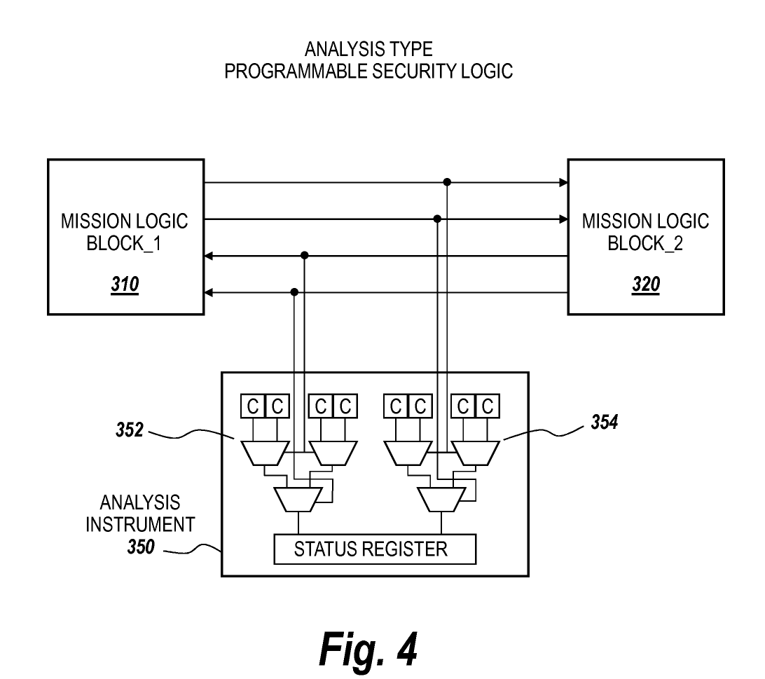

The analysis instrument 350 may monitor the mission logic blocks 310, 320, or may monitor communication between the mission logic blocks 310, 320, to determine whether the mission logic system has been subjected to tampering. The analysis instrument provides a flexible method to execute various security functions to protect the system. The analysis logic may operate on a single mission logic signal or a group of mission logic signals. The analysis logic can be used with any combination of transport and control logic, or stand alone as shown in FIG. 4. The analysis instrument 350 will be discussed in more detail below with respect to FIGS. 4 and 8-10.

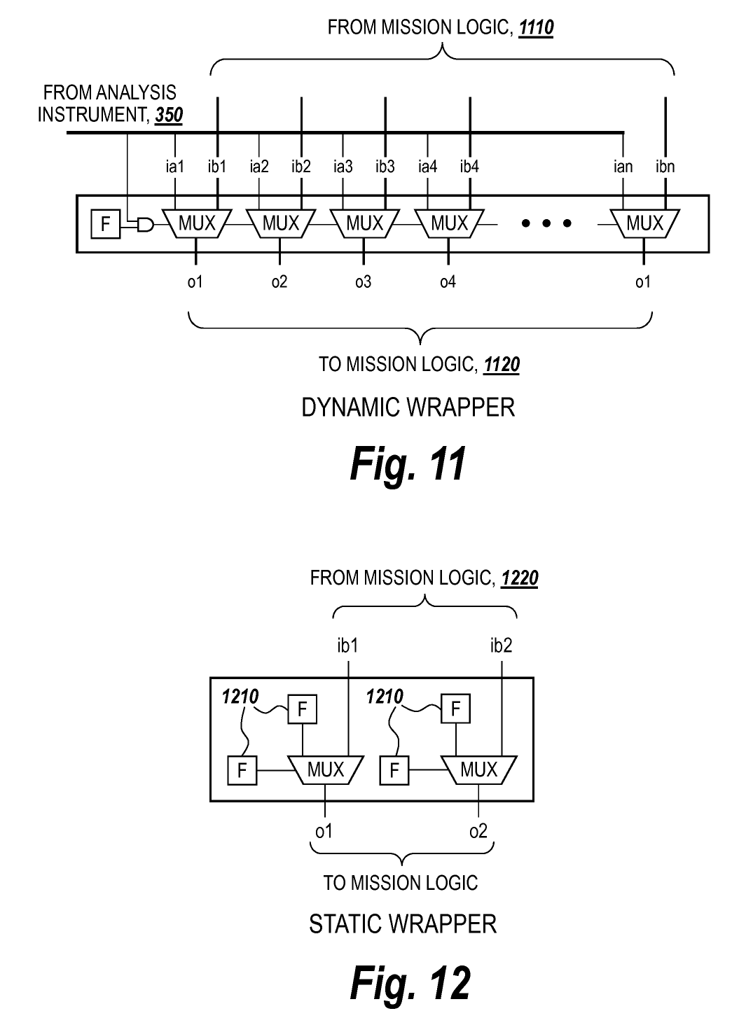

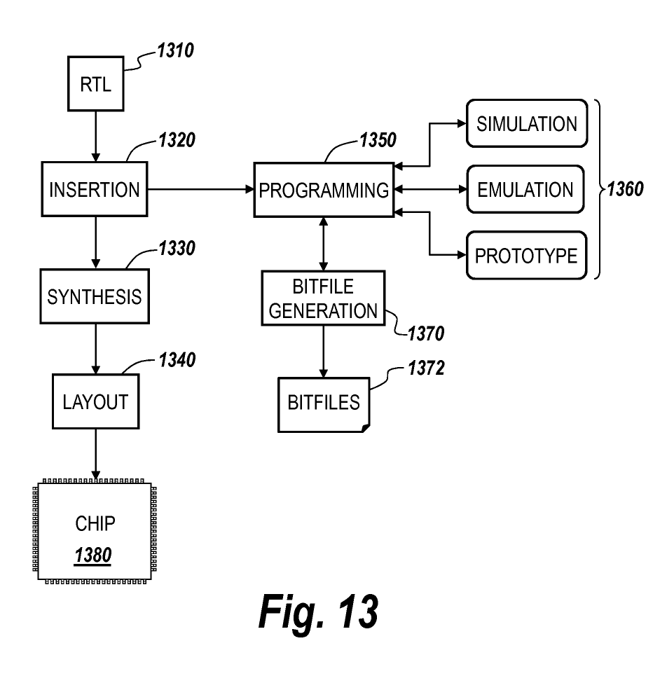

The control instruments 360 may enforce a protection mechanism when the analysis instrument 350 determines that the mission logic has been subjected to tampering. The control instrument 360 may provide a flexible method to control mission logic signals, and to override mission values with new values that are needed to protect the mission logic system. The control instruments 360 may respond to one or more notifications or instructions from the analysis instrument 350 to enact a security protocol. The control instruments 360 will be discussed in more detail below with respect to FIGS. 11 and 12.

The transport instrument 340 may range in size, for example, from a few hundred gates to a few thousand gates. The control instrument 360 may range in size, for example, from tens of gates to hundreds of gates. The analysis instrument 350 may range in size, for example, from a few thousand gates to twenty thousand gates or more. The uniqueness and variability of the programmable security logic may be achieved through highly parameterized logic generation programs, meaning that the size of each programmable security logic element may be user defined at design time.

In one embodiment, the programmable security logic block 300 may maintain a heartbeat or keep-alive signaling system with other programmable security logic resources and thus be used to detect abnormal behavior and attacks to neighboring circuits. In its simplest form, a heartbeat is implemented with a small counter on the source side to produce a periodic signal. This circuit produces a heartbeat signal when the programmable security logic is programmed properly and receiving a proper clock and reset signal. The receive side programmable security logic resource, a disparate resource, monitors the heartbeat signal for regular frequency. The unexpected absence or irregularity of the heartbeat signal may be an indication of an attack.

FIG. 4 is a block diagram showing one embodiment of an analysis instrument 350 in more detail. The analysis instrument may include one or more analysis circuits 352, 354, and one or more status registers 356.

In one embodiment, the analysis instrument 360 may include input signals, a programmable state machine, counters, timers, comparators, output registers and configuration registers. The analysis instrument 360 may operate on the input signals. The programmable state machine may be used to construct a input signal analysis function, for example, a bus protocol analyzer that detects specific transactions on a mission logic bus. In other words, the programmable state machine may be configured to implement a finite state machine (FSM) function that detects unwanted/nefarious functions in the mission logic. The counters, timers and comparators may be used in conjunction with the programmable state machine to implement a FSM function. The output registers may be used to store FSM results and may also be used to communicate to other analysis instruments 360 via general purpose output signals connected to said output registers. The function implemented in the analysis instrument 360 may be defined by the values stored in the configuration registers.

The analysis instrument 360 may monitor the mission logic blocks 310, 320, or may monitor communication between the mission logic blocks 310, 320, to determine whether the mission logic system has been subjected to tampering. The analysis instrument may be programmed to recognize a predetermined signal, or a combination of predetermined signals, to determine that the mission logic system is under attack

In some embodiments, the programmable security logic block 300 strictly provides analysis functionality. For example, the programmable security logic block 300 may include only one or more interfaces 330 and an analysis instrument 350 for performing a simple Boolean analysis.

An example of a Boolean security function is the monitoring of two IP block enables such as AESblockEnable and EthernetEnable where the EthernetEnable should not be asserted while the AESblockEnable is deasserted. This check can be performed by implementing the following Boolean function; illegal_state=EthernetEnable & !AESblockEnable.

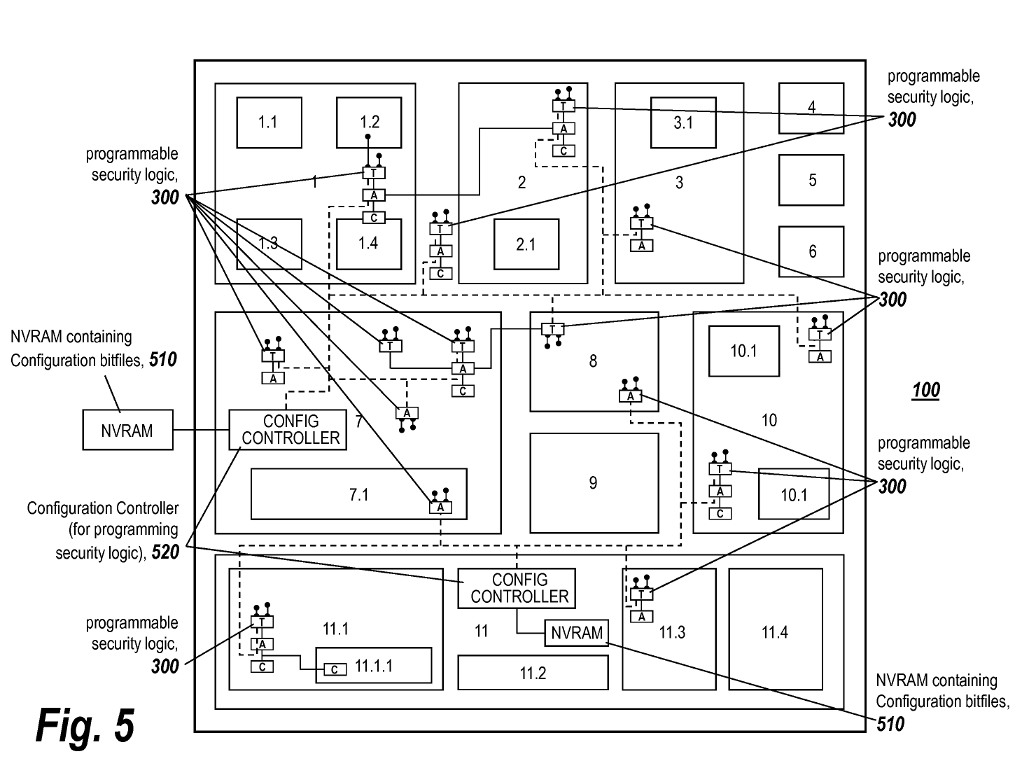

FIG. 5 is a block diagram of a mission logic system 100 with an embodiment of distributed programmable security logic blocks 300, showing how each instance of the programmable security logic blocks 300 may be different in form and in connectivity to adjacent instances.

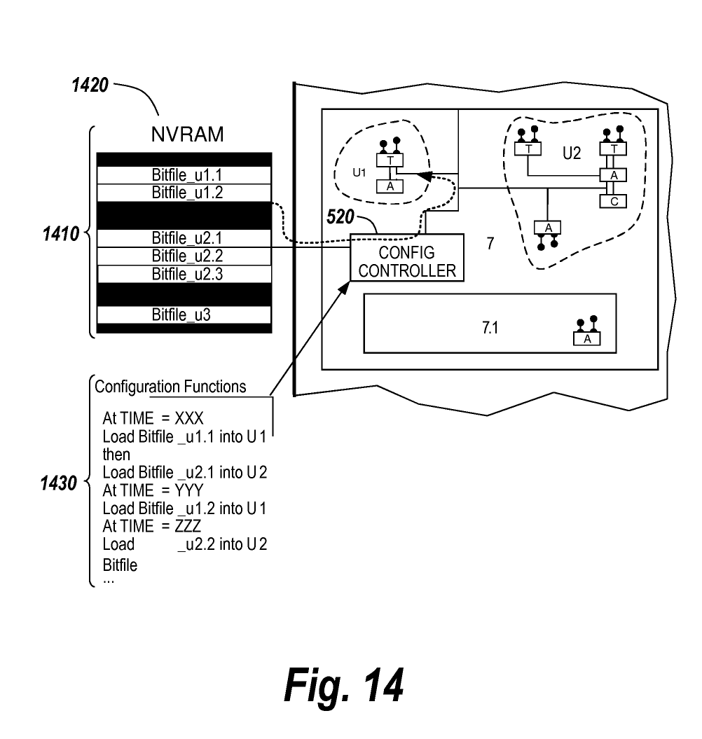

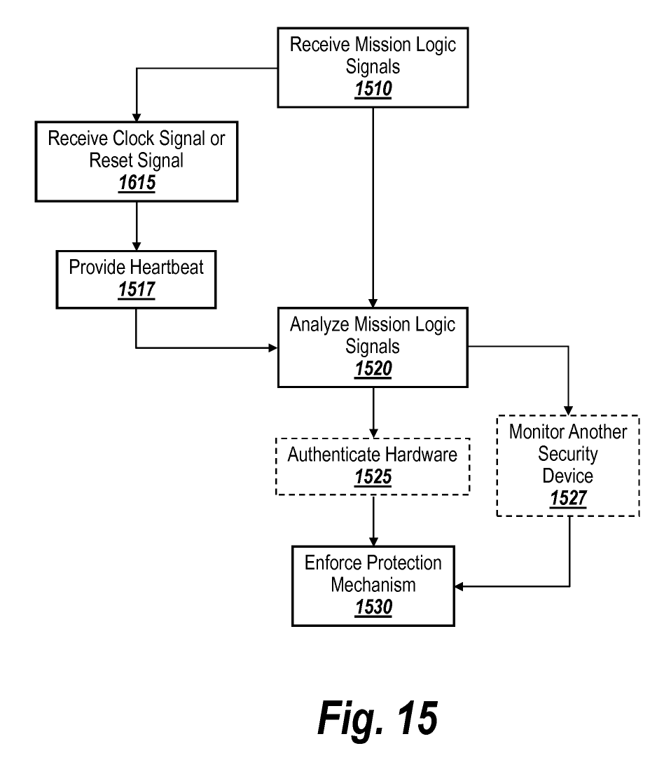

Multiple instances of the programmable security logic blocks 300 are distributed throughout the mission logic system as shown in FIG. 5. Each of these instances can be programmed to provide a unique security function. The security functions may be defined in security program configuration bitfiles 510 stored in on-chip and/or off-chip memory. The configuration bitfiles may be created within a design flow, for example during the programming step as shown in FIG. 13. How and when these bitfiles are loaded into programmable logic resources is managed via a configuration controller 520. The configuration controller 520 is discussed in more detail below with respect to FIG. 14.

Each instance of programmable logic 300, comprising (for example) the analysis logic instrument 350 and optionally the transport instrument 340 and control instruments 360, can be uniquely defined to provide the security functions in each locale. That is, the structure and available resources will be unique to each instantiation. In addition the connectivity between the mission logic and the programmable security logic will be unique, as will the connectivity between adjacent programmable security logic instances as shown in FIG. 5.

The transport logic functions are generally performed by multiplexers 610 as shown FIG. 6 and FIG. 7. FIG. 6 is a block diagram of a basic transport instrument having a multiplexer structure used to transport mission logic signals to analysis instruments 350. The transport instrument 340 provides a flexible method to route combinations of mission logic signals to the analysis logic 350.

FIG. 7 is a block diagram of a more advanced multiplexer structure used to transport mission logic signals to analysis instruments. The multiplexers 610 provide an efficient means to connect a large number of mission logic signals 620 and a smaller set of analysis logic input pins 630. It is the job of the multiplexers 610 to route the appropriate mission logic signals 620, based on the settings stored in a configuration register 710, from its input stage to its output stage.

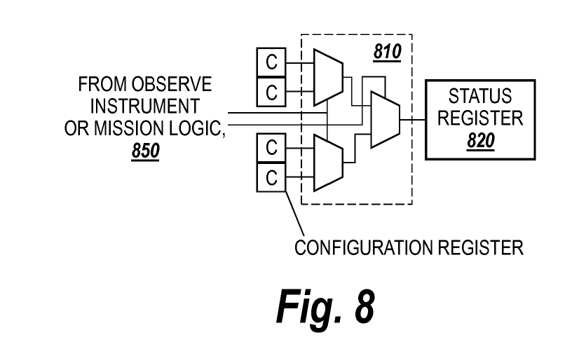

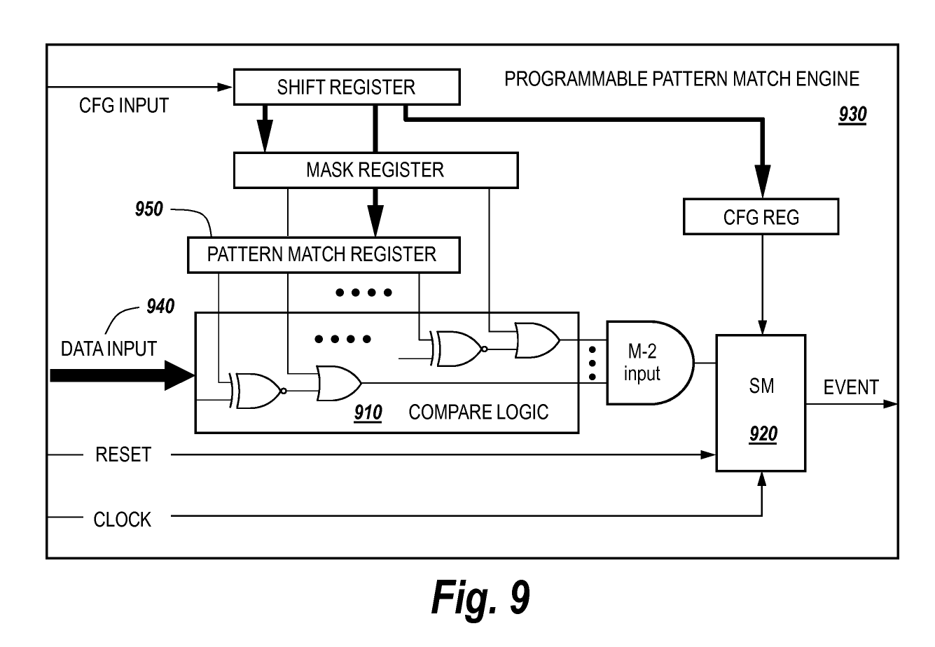

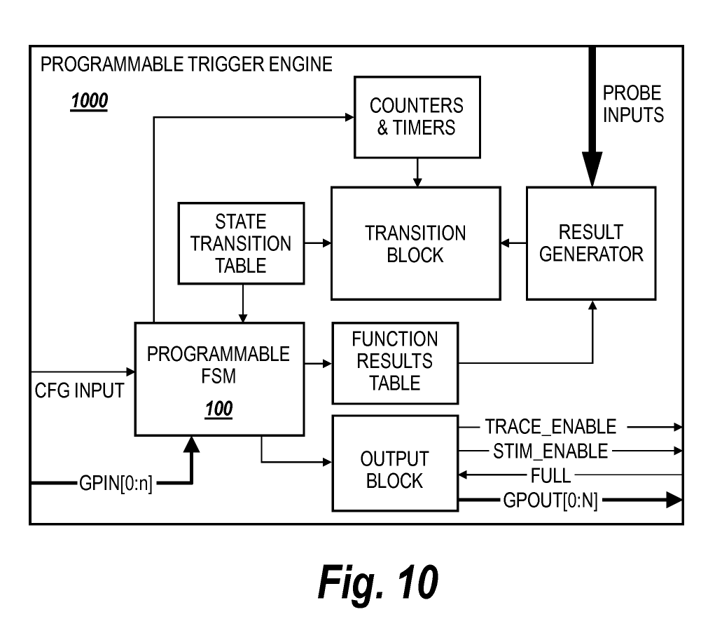

The analysis logic 350 may take a number of different forms as shown in FIG. 8, FIG. 9 and FIG. 10.

FIG. 8 is a block diagram of an analysis instrument 350 composed of Look-Up-Table (LUT) 810 and Status Register 820 used to perform security functions with Boolean logic. A LUT 810 is a data structure, usually an array or associative array, often used to replace a runtime computation with a simpler array indexing operation. The status register 820 provides a collection of flag bits that indicate the analysis results, namely whether the inputs 830 from the mission logic are behaving as expected (correctly).

The form of the analysis instrument 350 is dependent on the set of security functions envisioned at design time and anticipated in the future. For very simple security functions requiring basic Boolean logic, a LUT and status register 820 as shown in FIG. 8 may be sufficient. However, utilizing such simple resources may limit the flexibility to implement new and unanticipated security functions. Thus more complex and resource rich structures may be used.

For example, FIG. 9 is a block diagram of an analysis instrument 350 composed of a parameterize comparator 910 and a finite state machine (FSM) 920 used to perform security functions with pattern match logic. An FSM 920 is a model of behavior composed of a finite number of states, transitions between those states, and actions.

FIG. 9 shows a pattern match engine 930 that can compare mission logic signal values 940 to a set of values defined in a pattern match register 950. For example, to check for unauthorized write access to a privileged key space in non-volatile RAM (NVRAM), the analysis logic 350 checks for a pattern of NVRAM_WriteEnable=1, the NVRAM_Address=Ox080FE00, and the SystemMode==$normal_operating_mode.

FIG. 10 shows a more sophisticated programmable finite state machine structure 1000 that can analyze complex state sequences of mission logic signals using comparison logic, timers and counters, and a state machine providing if-then-else sequential coding. FIG. 10 is a block diagram of an analysis instrument 350 composed of a programmable finite state machine 1010, comparators, Boolean logic unit, and timers and counters used to perform security functions with advance sequential logic analysis.

For example, to ensure a proper boot sequence at both the hardware and software levels the finite state machine structure 1000 can check for the following sequence of events; a) reset de-asserted low for a minimum of X clock cycles, b) reset asserted high for a minimum of Y clock cycles and a maximum of Z clock cycles before the first instruction fetch, c) the first three instruction fetches are A and then B and then C.

FIGS. 11 and 12 depict an example of a dynamic control instrument and a static control instrument, respectively. A dynamic control instrument is an instrument that has the ability to change the state of mission logic signals in real-time or near-real time at mission logic system clock speeds. In static control instruments, the mission logic signal state is typically programmed or configured during a configuration stage and thus cannot be changed immediately to counteract a detected threat.

For example using a dynamic control instrument on a chip_select signal of a memory, upon detection of an attack the control instrument can dynamically de-assert the chip_select signal preventing any other mission logic resources from accessing this resource thereafter. Doing so with a static control instrument may not be as effective, because the latency (time) involved in programming/configuring the static control instrument leaves a window of opportunity for the memory resource to be tampered with before the countermeasure is realized. A static control instrument may be more effective at placing mission logic signals in certain states and holding them in those states indefinitely.

FIG. 11 is a block diagram of a dynamic control instrument 360. To provide dynamic control over mission logic signals, a structure similar to what is shown in FIG. 11 is connected to both the mission logic inputs 1110 and an analysis instrument 350. Mission logic output 1120 are provided on an output end of the control instrument 360.

Dynamic control over mission logic, as shown in FIG. 11, provides a real-time means to counteract security threats. Consider, for example, that the Mission Logic Block 320 as shown in FIG. 3 is a memory, and that the analysis instrument 350 is configured to check for an illegal read cycle access to memory address 4h′FE00. If the analysis instrument 350 detects an illegal access it can immediately activate the control instrument 360 and block the transmission of potentially secret data located at address 4h′FE00.

FIG. 12 is a block diagram of a static control instrument 360. In some cases, static control over mission logic signals is useful. In this case, the configuration registers 1210 control when the mission logic input signals 1220 are overridden and with what values. Static control logic may be more suitable than dynamic control logic when real-time activation is not necessary and certain configuration persistence is desired. For example, consider a scenario where an attack is detected and the countermeasure includes loading new configuration files into certain programmable security logic resources including static controllers to place the mission logic 100 into a fail-safe mode.

FIG. 13 is a flowchart showing an exemplary design flow. FIG. 13 shows the basic design flow steps for producing a Application Specific Standard Product (ASSP), ASIC or FPGA design. An ASSP is an integrated circuit that implements a specific function that appeals to a wide market.

The programmable security logic of the programmable security logic blocks may be described in a Register Transfer Level (RTL) form (step 1310). An RTL is commonly used in the electronics design industry to refer to the coding style used in hardware description languages that effectively guarantees the code model can be synthesized (converted to real logic functions) in a given hardware platform such as an FPGA.

The programmable security logic is inserted into mission logic described in a Register Transfer Level (RTL) form (step 1320). The mission logic circuitry is often described using a Hardware Description Language (HDL) such as Verilog or VHDL. Mission logic is also described using schematics.

Once the programmable security logic is inserted, the RTL is then synthesized (step 1330), which is a transformation process where the HDL is converted into a design implementation at the gate-level.

Layout (step 1340) follows synthesis. For ASSPs and ASICs, layout is a geometric exercise to determine where to place the logic elements and how to route the connections in a manner to achieve the desired timing constraints. For PLDs (FPGAs) layout is referred to as “Place and Route” For such devices, where the gates and routing resources are predetermined and fixed by the PLD vendors, the process involves resolving how to map the synthesized gate-level netlist to the available resources in a manner to achieve the desired timing constraints. A netlist is a list of component instances and inter-connections.

Once the insertion process 1320 is complete, a programming design step 1350 can commence. This process can occur concurrently with any of the synthesis 1330 or layout 1340 steps described. Programming design 1350 is the process of producing the configuration files that determine how the programmable security logic functions. The programmable security logic resources are configured using a command language or through a graphical user interface (see DAFCA's ClearBlue as an example). This process is analogous to how one might program a general purpose process using the C-language. The programmable security logic implementations can be tested by executing the both the mission logic and the programmable security logic on a simulation, emulation or some prototype platform such as a FPGA (step 1360).

As a result of the programming step 1350, a configuration bitfile 1372 may be generated (step 1370). The configuration bitfile may contain binary values (1s and 0s) that define the function implemented in the programmable security logic. For example, if a programmable security logic instrument contains four configuration registers there may be up to sixteen (2⁴=16) security functions that can be performed. In practice, there may be many instances of such programmable security logic instruments embedded in the mission logic. As such, the bitfile may be a concatenation of binary values that must be loaded into the programmable security logic instruments at run-time. The format of the bitfile and the manner in which the bitfile is loaded at run-time is a function of the access mechanism(s) and configuration controller(s) (e.g. the communication link(s) and controller(s) that reside between the bitfiles storage locations and the instruments).

For PLDs, once placing and routing is complete (step 1340) and the configuration bitfile 1372 is generated, the implementation can be downloaded to a physical device 1380. For ASSPs and ASICs, the output of the layout processes includes a design database that is used to fabricate the semiconductor device. While not explicitly shown, those skilled in the art understand that the insertion step 1320 can also be performed after synthesis is complete, on the gate-level netlist.

The programmable security logic within each domain of the mission logic system is inserted at the RTL level and integrated such that distinctions between the mission logic and programmable security logic are not evident once the RTL is synthesized and subsequently transformed for use in the semiconductor device. The function of the security logic is not visible by analyzing the netlist since it depends on its run-time configuration. Moreover, this function can be repeatedly changed during the normal system operation.

The programmable security logic within each domain of the mission logic system can be constructed using unique combinations of programmable logic. Such irregular programmable logic structures used from domain to domain and chip to chip prevent reverse-engineering and malware intrusion.

The programmable security logic can be reconfigured in the factory, in the field and during normal run-time operation, thus providing protection against previously unknown or unanticipated security threats, while also providing run-time protection through varying security functionality. Consider the analogy to using infrared laser monitoring to protect a physical space. Instead of mounting the infrared lasers in a static position, they are designed to operate in random positions over time; an attacker cannot easily anticipate how to move to avoid detection. So it is with distributed and dynamically reprogrammable security logic.

The physical device 1380 may be a programmable security logic block as depicted in FIGS. 2 and 3. The physical device 1380 may be controlled or configured by a configuration controller 520, as shown in FIG. 5. FIG. 14 is a block diagram showing an exemplary configuration controller 520 in more detail. The configuration controller 520 as shown in FIG. 5 and FIG. 14 can be implemented in hardware or software. The configuration controller 520 can be constructed in a dedicated resource or can be implemented on a shared processor.

FIG. 14 shows one embodiment of a configuration controller 520 that loads a multitude of configuration bitfiles 1410 from an external NVRAM 1420 into programmable logic resources during run-time. Those skilled in the art will recognize that the configuration controller 520 can also load bitfiles 1410 conditionally based on mission logic events or based on results from various security functions, as depicted in the configuration functions 1430. For improved security, the bitfiles 1410 for the most critical security functions may be loaded using dedicated configuration controller resources resistant to malware and other attacks exhibited on or through general purpose processors.

In summary, the present application provides security functions for securing mission logic systems including one or more hardware subsystems. The security functions are implemented in discrete programmable security logic blocks distributed throughout the hardware subsystem. Each instance of the programmable security logic resource can be unique and optimized to match the security requirements within the locale.

The programmable security logic resources can be utilized collectively to provide coordinated security coverage of multiple regions of the mission logic system. The programmable security logic resources can be used to monitor mission logic system behavior and to provide real-time countermeasures to actively thwart attacks. Such countermeasure capability requires the control logic.

The methods described herein are particularly useful in virtual machines where the software is intended to operate on multiple hardware platforms and the authenticity of the hardware platform is critical. Current protection methods establish a means to secure the software against unauthorized changes but do not adequately address the software vulnerability and system vulnerability when the hardware platform is untrusted. For example, imagine a hardware system that makes unauthorized copies of sensitive data and transmits such data through external interfaces without software intervention or knowledge. Using the apparatuses and methods described herein, the signals transmitted by the hardware system may be identified by the analysis logic 350, and the control logic 360 may prevent the hardware system from copying or transmitting the data.

One exemplary security method according to an exemplary embodiment is depicted in FIG. 15. At step 1510, one or more programmable security logic blocks receive mission logic signals. Although the programmable security logic blocks may receive mission logic signals from one or more subsystems of the mission logic system, the programmable security logic blocks may otherwise be entirely independent of the mission logic system. For example, the security logic blocks may not rely on the resources of the mission logic system to perform security functions, and may operate autonomously from the mission logic system.

The mission logic signals may be received on an interface and routed using one or more transport instruments. As a part of, or separately from, the mission logic signals, the security logic block may receive a clock signal or a reset signal (step 1515) and may provide a heartbeat (step 1517) indicating that the security logic block is receiving the appropriate signals and is performing properly.

At step 1520, the mission logic signals received at step 1510 may be analyzed to determine whether the mission logic system is performing in an authorized manner or an unauthorized manner. The analysis may be performed, for example, by an analysis instrument. The analysis may involve, for example, monitoring the mission logic signals to detect a predetermined signal and/or monitoring the mission logic signals to detect a predetermined sequence of signals.

Optionally, the analysis instrument may be used to authenticate hardware (step 1525) and/or monitor another security logic block in the mission logic system.

At step 1530, one or more control instruments may enforce a protection mechanism on the basis of the analysis done at step 1520. The protection mechanism may be enforced when it is determined that the mission logic system is performing in an unauthorized manner.

The protection mechanism may involve a number of security functions. For example, the protection mechanism may block access to a mission logic system resource in response to a determination that the system is performing in an unauthorized manner. Alternatively, the protection mechanism may involve erasing predetermined data in response to a determination that the system is performing in an unauthorized manner, or disabling one or more communication peripherals in order to quarantine the system in response to a determination that the system is performing in an unauthorized manner.

The invention has been described in terms of particular embodiments. Other embodiments are within the scope of the following claims. For example, the steps of the invention can be performed in a different order and still achieve desirable results. This application is intended to cover any adaptation or variation of the present invention. It is intended that this invention be limited only by the claims and equivalents thereof.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, a computing device (e.g., a workstation) or a user of a computing device, unless otherwise stated.

The scope of the invention is defined by the claims and their equivalents.

1. An electronic device for use in a mission logic system comprising one or more mission logic subsystems, the electronic device comprising:
an interface receiving communications associated with the one or more subsystems;
an analysis instrument for monitoring the one or more subsystems or communication between the one or more subsystems to determine whether the mission logic system is performing in an authorized or unauthorized manner; and
a control instrument for enforcing a protection mechanism when the analysis instrument determine that the mission logic is performing in an unauthorized manner.

2. The electronic device of claim 1, wherein the electronic device is autonomous.

3. The electronic device of claim 1, wherein the interface receives one or more signals sent from or to the one or more subsystems, and the analysis instrument monitors the signals to detect a predetermined signal.

4. The electronic device of claim 1, wherein the interface receives one or more signals sent from or to the one or more subsystems, and the analysis instrument monitors the signals to detect a predetermined sequence of signals.

5. The electronic device of claim 1, wherein the mission logic system provides mission logic signals, and the interface comprises transport logic for routing combinations of the mission logic signals to the analysis instrument.

6. The electronic device of claim 1, wherein the electronic device receives at least one of a clock signal or a reset signal, and further provides a heartbeat signal indicating that the electronic device is programmed properly and receiving a proper clock signal or reset signal.

7. The electronic device of claim 1, wherein the protection mechanism comprises blocking access to a system resource in response to a determination by the analysis instrument that the system is performing in an unauthorized manner.

8. The electronic device of claim 1, wherein the protection mechanism comprises erasing predetermined data in response to a determination by the analysis instrument that the system is performing in an unauthorized manner.

9. The electronic device of claim 1, wherein the protection mechanism comprises disabling one or more communication peripherals in order to quarantine the system in response to a determination by the analysis instrument that the system is performing in an unauthorized manner.

10. The electronic device of claim 1, wherein the analysis instrument performs hardware authentication.

11. The electronic device of claim 1, wherein the electronic device is a first security device and a second security device is provided in the mission logic system, and wherein the analysis instrument of the first security device monitors the second security device to determine whether the second security device is performing in an unauthorized manner.

12. A method for determining whether a mission logic system is performing in an unauthorized manner, comprising:
receiving, at an electronic device that operates independently of the mission logic system, one or more mission logic signals;
analyzing the mission logic signals to determine whether the mission logic system is performing in an authorized manner or an unauthorized manner; and
enforcing a protection mechanism when it is determined that the mission logic system is performing in an unauthorized manner.

13. The method device of claim 12, wherein the analyzing comprises monitoring the mission logic signals to detect a predetermined signal.

14. The method of claim 12, wherein analyzing comprises monitoring the mission logic signals to detect a predetermined sequence of signals.

15. The method of claim 12, further comprising:
receiving, at the electronic device, at least one of a clock signal or a reset signal; and
providing a heartbeat signal indicating that the electronic device is programmed properly and receiving a proper clock signal or reset signal.

16. The method of claim 12, wherein the protection mechanism comprises blocking access to a mission logic system resource in response to a determination that the system is performing in an unauthorized manner.

17. The method of claim 12, wherein the protection mechanism comprises erasing predetermined data in response to a determination that the system is performing in an unauthorized manner.

18. The method of claim 12, wherein the protection mechanism comprises disabling one or more communication peripherals in order to quarantine the system in response to a determination that the system is performing in an unauthorized manner.

19. The electronic device of claim 12, further comprising authenticating one or more subsystems of the mission logic system.

20. The electronic device of claim 12, wherein the electronic device is a first security device and a second security device is provided in the mission logic system, and further comprising:
monitoring the second security device using the first security device to determine whether the second security device is performing in an unauthorized manner.
